(19) United States
(12) Patent Application Publication
(10) Pub. No.: US 2025/0282657 A1
(43) Pub. Date: Sep. 11, 2025

(54) ELECTRODEIONIZATION DEVICE AND METHOD FOR PRODUCING PURE WATER

(71) Applicant: ORGANO CORPORATION, Tokyo (JP)

(72) Inventors: Yuri HOSHINO, Tokyo (JP); Keisuke SASAKI, Tokyo (JP)

(73) Assignee: ORGANO CORPORATION, Tokyo (JP)

(21) Appl. No.: 18/867,527

(22) PCT Filed: Apr. 11, 2023
(86) PCT No.: PCT/JP2023/014651

§ 371 Date: Nov. 20, 2024

(30) Foreign Application Priority Data
May 25, 2022 (JP) 2022-084986

(51) Int. Cl. C02F 1/469; B01D 61/48

(52) U.S. Cl. CPC C02F 1/4695; B01D 61/48

(57) ABSTRACT

In an electrodeionization (EDI) device including a deionization chamber and a concentration chamber provided on a side to a cathode of the deionization chamber, the deionization chamber is divided into a plurality of regions aligned in a flow direction of water to be treated. A first region, which is a region located at most upstream side of flow of the water, is filled with a mixture of an anion exchanger and a cation exchanger such that a volume ratio of the cation exchanger to a total volume of the ion exchangers is more than 50% and 90% or less, and a second region, which is a region located at most downstream side, is filled with a mixture of the anion exchanger and the cation exchanger such that a volume ratio of the anion exchanger to a total volume of ion exchangers is more than 50% and 90% or less.

### TECHNICAL FIELD

The present invention relates to an electrodeionization device, and a method for producing pure water using the electrodeionization device.

### BACKGROUND ART

As one of apparatuses for producing deionized water from water to be treated, there is an electrodeionization (EDI) device. Hereafter, electrodeionization device is also referred to as EDI device. The EDI device is a device in which electrophoresis and electrodialysis are combined, and has a configuration in which a deionization chamber partitioned by a pair of ion exchange membranes is disposed between an anode and a cathode. In the EDI device, at least its deionization chamber is filled with an ion exchange resin. By passing the water to be treated through the deionization chamber in a state in which a direct current voltage is applied between the anode and cathode in the EDI device, deionization treatment is performed on the water to be treated in the deionization chamber, and treated water from which ionic components have been removed flows out from the deionization chamber. In order to increase the efficiency of removing carbonic acid components, silica components and the like contained in the water to be treated and to increase the current density while suppressing an increase in voltage increase, in the EDI device described in Patent Literature 1, a compartment member is disposed in the deionization chamber to partition the deionization chamber into a large number of small chambers, and the anion exchange resin and the cation exchange resin are mixed and filled in the deionization chamber so that the anion exchange resin is equal to or larger than the cation exchange resin in the volume ratio over the entire region in the deionization chamber. Furthermore, in the EDI device described in Patent Literature 1, the mixing ratio of the anion exchange resin is set to 66 to 80 vol. % in one side of the upstream side and the downstream side along the flow of water in the deionization chamber, and the mixing ratio of the anion exchange resin is set to 50 to 65 vol. % on the other side.

With regard to the structure of the EDI device, Patent Literature 2 discloses that frames with openings and ion exchange membranes are alternately stacked, and ion exchanges are filled in the openings of the frames.

### CITATION LIST

### Patent Literature

Patent Literature 1: JP 2005-193205 A
Patent Literature 2: JP 2015-199038 A

### SUMMARY OF INVENTION

### Technical Problem

In the EDI device described in Patent Literature 1, since the deionization chamber is filled with a higher proportion of the anion exchange resin than the cation exchange resin, a high removal rate of anions is obtained. On the other hand, as described in paragraph of Patent Literature 1, “If the ratio of anion exchange resin is increased, the generated amount of OH ions increases, but the amount of H⁺ ions decreases, which reduces the removal performance of Nations and makes the specific resistance of the treated water worse,” since the ratio of the cation exchange resin is small, the removal performance of cations such as sodium ions (Na⁺) is reduced, and the specific resistance of the treated water when the EDI device is operated for a long time is decreased. In other words, the EDI device described in Patent Literature 1 has the problem that the quality of the treated water is degraded. In the EDI device described in Patent Literature 1, the deionization chamber is divided into many small chambers to prevent leakage of sodium ions, but there is a room for an improvement from the viewpoint of manufacturability.

The object of the present invention is to provide an EDI device that can prevent a decrease in the specific resistance of the treated water due to cation leakage while maintaining anion removal efficiency, and a method for producing pure water using such an EDI device.

### Solution to Problem

The EDI device (electrodeionization device) according to the present invention is an electrodeionization device including: an anode; a cathode; a deionization chamber located between the anode and the cathode and partitioned by an anion exchange membrane located on a side to the anode and a cation exchange membrane located on a side to the cathode, the deionization chamber being filled with an anion exchanger and a cation exchanger; and a concentration chamber provided on a side to the cathode of the cation exchange membrane and filled with an anion exchanger and a cation exchanger, the electrodeionization device is characterized in that: the deionization chamber is divided into a plurality of regions so that the plurality of regions are aligned in a flow direction of the water to be treated in the deionization chamber, and among the plurality of regions, a region located at most upstream side of flow of the water to be treated is defined as a first region, and a region located at most downstream side is defined as a second region, and the first region is filled with a mixture of the anion exchanger and the cation exchanger such that a volume ratio of the cation exchanger to a total volume of the anion exchanger and the cation exchanger in the first region is more than 50% and 90% or less; and the second region is filled with a mixture of the anion exchanger and the cation exchanger such that a volume ratio of the anion exchanger to a total volume of the anion exchanger and the cation exchanger in the second region is more than 50% and 90% or less.

The method for producing pure water according to the present invention is characterize in that: the electrodeionization device according to present invention is used; and the water to be treated with a sodium ion concentration of 0.1 mg/L or more and 0.6 mg/L or less is supplied to the deionization chamber while applying a direct current voltage between the anode and the cathode to obtain pure water which is deionized water. Alternatively, the method for producing pure water according to the present invention is characterized in that: the electrodeionization device according to the present invention is used; and supplying water to be treated with a total carbonic acid concentration of 0.5 mg-CO₂/L or more and 5.0 mg-CO₂/L or less is supplied to the deionization chamber while applying a direct current voltage between the anode and the cathode to obtain pure water which is deionized water.

In the present invention, the anion exchanger and the cation exchangers are collectively referred to as an ion exchanger. The volume ratio to the entirety of the anion exchanger and cation exchanger is determined based on their apparent volume, i.e., bulk volume, including voids present between these ion exchangers in their free state. The free state refers to a state in which the ion exchangers are not restrained in a space such as a deionization chamber or a concentration chamber.

In the EDI device according to the present invention, when the anion exchanger and the cation exchanger are mixed and filled in the deionization chamber, the deionization chamber is divided into a plurality of regions such that the plurality of regions are arranged toward the flow direction of the water to be treated, that is, the deionization chamber is divided into a plurality of regions along the flow of the water to be treated. In the region at the most upstream side, the proportion of the cation exchanger is increased, and in the region of the most downstream side, the proportion of the anion exchanger is increased. As a result, the removal of the cations such as sodium ions is preferentially performed at the position on the most upstream side in the deionization chamber, and the removal of the anions including the weak acid components is preferentially performed at the position on the most downstream side. This makes it possible to stably operate the EDI device over a wide range with respect to the water quality of the water to be treated, and to prevent the reduction of the specific resistance of the treated water due to leakage of cations while obtaining high removal efficiency of anions including weak acid components. The weak acid components here include, for example, carbonic acid, silica, silicic acid compounds, boric acid, and other boron components.

In the present invention, the deionization chamber is divided into a plurality of regions along the flow of the water to be treated, but the number of regions generated by the division can be two or more. It is not necessary to provide a member such as a spacer for physically separating the divided regions, and the ion exchanger may be filled so that the mixing ratio changes for each region when the deionization chamber is filled with the ion exchangers. When divided into two regions, the region of the most upstream side refers to a region at the upstream side of the two regions, and the region of the most downstream side refers to a region at the downstream side of the two regions. When the deionization chamber is divided into three or more regions, regions except the regions at most upstream side and the most downstream side may be filled with the anion exchange resin or the cation exchange resin in a single bed manner, or filled with a mixture of the anion exchange resin and the cation exchange resin at any mixing ratio.

When the volume ratio of the cation exchanger to the total volume of the anion exchanger and the cation exchanger in the first region, which is the region on the most upstream side in the deionization chamber, is defined as a first volume ratio, the first volume ratio is more than 50% but 90% or less, preferably 60% or more but 85% or less, and more preferably 70% or more but 80% or lees. When the volume ratio of the anion exchanger to the total volume of the anion exchanger and the cation exchanger in the second region, which is the region on the most downstream side in the deionization chamber, is defined as a second volume ratio, the second volume ratio is more than 50% but 90% or less, preferably 60% or more but 85% or less, and more preferably 70% or more but 80% or less.

The thickness of the layer of the ion exchanger in each of the plurality of regions along a direction orthogonal to the flow direction of the water to be treated in the deionization chamber is preferably 10 mm or more and 25 mm or less. and more preferably about 15 mm or more and 20 mm or less. When an anion exchange resin is used as the anion exchanger to be filled in the deionization chamber, it is possible to use a general anion exchange resin with an average particle size of about more than 0.4 mm but 1 mm or less. However, the average particle size of the anion exchange resin is preferably 0.1 mm or more but 0.4 mm or less, and more preferably about 0.25 mm or more but 0.35 mm or less.

### Advantageous Effects of Invention

According to the present invention, it is possible to obtain an EDI device that can prevent a decrease in the specific resistance of the treated water due to cation leakage while maintaining anion removal efficiency, and a method for producing pure water using such an EDI device.

### BRIEF DESCRIPTION OF DRAWINGS

FIG. 1 is a view illustrating an EDI device according to one embodiment of the present invention.

FIG. 2 is a schematic cross-sectional view showing the mechanical structure of the EDI device.

FIG. 3 is an assembly perspective view of the EDI device shown in FIG. 2.

FIG. 4 is a view showing an EDI device according to another embodiment.

FIG. 5 is a view showing an EDI device according to another embodiment.

FIG. 6 is a diagram illustrating the transfer of carbonic acid from the concentration chamber to the deionization chamber.

### DESCRIPTION OF EMBODIMENTS

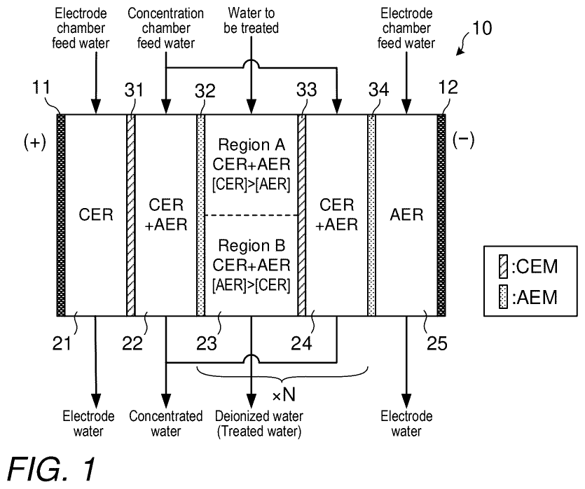

Next, embodiments for implementing the present invention will be described with reference to the drawings. FIG. 1 shows EDI device 10 according to one embodiment of the present invention. In this EDI device 10, concentration chamber 22, deionization chamber 23, and concentration chamber 24 are provided, between anode chamber 21 provided with anode 11 and cathode chamber 25 provided with cathode 12, in this order from the side of anode chamber 21. Anode chamber 21 and concentration chamber 22 are adjacent to each other across cation exchange membrane (CEM) 31, concentration chamber 22 and deionization chamber 23 are adjacent to each other across anion exchange membrane (AEM) 32, deionization chamber 23 and concentration chamber 24 are adjacent to each other across cation exchange membrane 33, and concentration chamber 24 and cathode chamber 25 are adjacent to each other across anion exchange membrane 34. Therefore, deionization chamber 23 is disposed between anode 11 and cathode 12, and is partitioned by anion exchange membrane 32 disposed on the side to anode 11 and cation exchange membrane 33 disposed on the side to cathode 12. Anode chamber 21 and cathode chamber 25 are collectively referred to as an electrode chamber.

Water to be treated is supplied to deionization chamber 23, and deionized water (treated water) resulting from the deionization treatment of the water to be treated flows out of deionization chamber 23. Concentration chambers 22 and 24 are supplied with concentration chamber feed water, and discharge concentrated water. Both anode chamber 21 and cathode chamber 25 are supplied with electrode chamber feed water, and discharge electrode water. The electrode chamber can be configured to also serve as concentration chambers 22 and 24 adjacent to the electrode chamber. In addition, the water flow in each of anode chamber 21, concentration chamber 22, deionization chamber 23, concentration chamber 24, and cathode chamber 25 shown in FIG. 1 is an example, and the direction of water flow in each of these chambers is arbitrary. For example, the flow of water in each chamber may be in the opposite direction to that shown in FIG. 1, independently for each chamber.

An anion exchanger and a cation exchanger are mixed and arranged inside deionization chamber 23 as an ion exchange resin layer. In the present embodiment, an anion exchange resin (AER) and a cation exchange resin (CER) are used as the anion exchanger and the cation exchanger, respectively, and the anion exchange resin and the cation exchange resin are mixed, i.e., in a mixed bed (MB) configuration, and filled into deionization chamber 23. In the figure, “CER+AER” indicates that the cation exchange resin and the anion exchange resin are packed in a mixed bed state. The interior of deionization chamber 23 is divided into two regions, region A and region B, along the flow of the water to be treated in deionization chamber 23. Region A is a region on the most upstream side along the flow of the water to be treated, that is, the region on the inlet side of the water to be treated, and region B is a region on the most downstream side along the flow of the water to be treated, that is, the region on the outlet side of the deionized water.

Although the anion exchange resin and the cation exchange resin are filled in the mixed bed manner in both regions A and B, the mixing ratio of the anion exchange resin and the cation exchange resin is different between the regions. In region A, which is on the inlet side of the water to be treated, the volume ratio of the cation exchange resin to the total volume of the anion exchange resin and the cation exchange resin filled in the mixed bed configuration is more than 50% and 90% or less. Therefore, region A contains more cation exchange resin than anion exchange resin in consideration of the volume ratio. On the other hand, in region B, which is on the outlet side of the deionized water, the volume ratio of the anion exchanger to the total volume of the anion exchange resin and the cation exchange resin filled in the mixed bed configuration is more than 50% and not more than 90%. Region B contains more anion exchange resin than cation exchange resin in consideration of the volume ratio. A partition wall or a separator is not provided between region A and region B, and the water to be treated that has flown through interspaces between the particles of the ion exchange resin in region A flows as it is into interspaces between the particles of the ion exchange resin in region B. Even when a partition is provided between region A and region B, a mesh or net-like simple partition can be used so that the ion exchange resins are not mixed between both regions. In the figure, “[CER]” represents the volume ratio of the cation exchange resin relative to the total volume of the anion exchange resin and the cation exchange resin that are filled in the mixed bed configuration therein. Similarly, “[AER]” represents the volume ratio of the anion exchange resin to the total volume of the cation exchange resin and the anion exchange resin filled in the mixed bed configuration therein.

The volume of the ion exchange resin in the present embodiment is the volume of the ion exchange resin in its free state, i.e., the apparent volume of the ion exchange resin, including the interspaces between the particles of the ion exchange resin, when the ion exchange resin is not constrained by spaces such as deionization chamber 23 and concentration chamber 24. Thus, the total volume of the anion exchange resin and the cation exchange resin packed in a mixed bed configuration is the apparent volume of the mixture of the anion exchange resin and the cation exchange resins in the free state. The volume of the anion exchange resin or cation exchange resin alone is the apparent volume of each ion exchange resin in its free state alone before mixing the anion exchange resin and the cation exchange resin, which can be determined by separating each ion exchange resin from the mixture of the anion exchange resin and the cation exchange resin and then measuring the volume of each ion exchange resin after the separation.

For deionization chamber 23 and concentration chamber 24, the length along the direction of the electric field between anode 11 and cathode 12 is called thickness. The thickness is defined in the same way for the layers of the ion exchange resin filled in deionization chamber 23 and concentration chamber 24. This thickness direction is orthogonal to the direction of water flow in deionization chamber 23 and concentration chamber 24. A decrease in the quality of the deionized water discharged from deionization chamber 23 was observed when the thickness of the ion exchange resin layer in deionization chamber 23 was less than 9 mm. Therefore, the thickness of the ion exchange resin layer in deionization chamber 23 is preferably 10 mm or more but 25 mm or lees, and more preferably 15 mm or more but about 20 mm or less.

Although a general ion exchange resin is bead-like or granular, and its standard particle size is greater than 0.4 mm and less than about 1 mm, it has been proposed to fill the deionization chamber with ion exchange resins of smaller particle size in order to improve the quality of the treated water in the EDI device. In EDI device 10 of the present embodiment, it is possible to fill deionization chamber 23 with a general ion exchange resins having a particle size of more than 0.4 mm. However, in EDI system 10 of the present embodiment, the average particle size of ion exchange resins, especially the anion exchange resin, that are filled in deionization chamber 23 is preferably 0.1 mm or more and 0.4 mm or less, expressed as the harmonic mean diameter, and more preferably, 0.25 mm or more but about 0.35 mm or less. Although the average particle size can be calculated by determining the particle size distribution of the ion exchange resin using a sieve, but the value described in a catalog by the manufacturer of the ion exchange resins may be used as the average particle size in the present embodiment.

In addition, in EDI device 10, a cation exchange resin is filled in anode chamber 21, an anion exchange resin and a cation exchange resin are filled in concentration chamber 22 in a mixed bed configuration, and an anion exchange resin is filled in cathode chamber 25. Concentration chamber 22 may be filled with an anion exchange resin in a single bed configuration. In concentration chamber 24, which is adjacent to deionization chamber 23 across cation exchange membrane 33 on the side to cathode 12 of deionization chamber 23, an anion exchange resin and a cation exchange resin are packed. Although anode chamber 21, concentration chamber 22, and cathode chamber 25 do not necessarily need to be filled with ion exchange resins, it is preferable that anode chamber 21, concentration chamber 22, and cathode chamber 25 are also filled with ion exchange resins to lower the DC voltage that must be applied between anode 11 and cathode 12 during operation of EDI device 10. The filling rate of the ion exchanger such as the ion exchange resin in at least one of deionization chamber 23 and concentration chamber 24 is 100% or more and 110% or less, more preferably 105% or more and 110% or less. The filling rate here is a value obtained by passing water through the space filled with the ion exchanger while applying a DC voltage between anode 11 and cathode 12 to put the ion exchanger in a regenerated state, and then dividing the apparent volume of the ion exchanger, which is taken out from the space, in its free state by the volume of the space. The space filled with the ion exchangers here is deionization chamber 23 or concentration chamber 24.

Next, we will explain the ion exchange resins in EDI device 10 of the present embodiment that can be filled and used in deionization chamber 23, and concentration chamber 24 located on the cathode side of deionization chamber 23 as well as filled and used in anode chamber 21, concentration chamber 22, and cathode chamber 25. In general, as the polymer matrix of ion exchange resins, there are a copolymer of styrene-divinylbenzene used in ion exchange resins which are called “styrene-based,” a copolymer of acrylic acid-divinylbenzene used in ion exchange resins which are called “acrylic,” and so on. Ion exchange resins are obtained by modifying these polymer matrixes with ion exchange groups, and are broadly classified into cation exchange resins, in which ion exchange groups with acidity are used, and anion exchange resins, in which ion exchange groups with basicity are used. Ion exchange resins are further distinguished by the type of ion exchange group introduced, such as strongly acidic cation exchange resins, weakly acidic cation exchange resins, strongly basic anion exchange resins, and weakly basic anion exchange resins. Examples of the strongly basic anion exchange resin include a resin with a quaternary ammonium group as an ion exchange group, and examples of the weakly basic anion exchange resin include a resin with a primary amine, a secondary amine, or a tertiary amine as an ion exchange group. Examples of the strongly acidic cation exchange resin include a resin with a sulfonic acid group as an ion exchange group, and examples of the weakly acidic cation exchange resin include a resin with a carboxyl group as an ion exchange group. As the ion exchange resin filled in the device according to the present invention, any of these types of ion exchange resins can be used.

Next, the operation of EDI device 10 of the present embodiment will be described. In EDI device 10 of the present embodiment, as in an ordinary EDI device, water to be treated is supplied to deionization chamber 23 and the feed water is supplied to anode chamber 21, concentration chambers 22 and 24, and cathode chamber 25 while a DC voltage is applied between anode 11 and cathode 12. In deionization chamber 23, the ion components in the water to be treated are desalted by the ion exchange resin, and the ion exchange resin is regenerated by H⁺ and OH ions which are produced by dissociation of water due to the applied DC voltage. Sodium ion (Na⁺) concentration of the water to be treated is, for example, 0.1 mg/L or more and 0.6 mg/L or less. By supplying such water to be treated to deionization chamber 23, pure water with a specific resistance exceeding 10 MΩ-cm can be obtained from deionization chamber 23 as deionized water over a long period of time. The total carbonic acid concentration in the water to be treated is, for example, 0.5 mg-CO₂/L or more and 5.0 mg-CO₂/L or less.

In EDI device 10 shown in FIG. 1, in deionization chamber 23, region A which is located on the most upstream side of the flow of the water to be treated is filled with relatively large amount of the cation exchange resin. Therefore, in this region A, cations in the water to be treated are preferentially removed. Region B which is located on the most downstream side of the flow of the water to be treated is filled with relatively large amount of the anion exchange resin, and in this region B, anions in the water to be treated are preferentially removed. Since the anions are removed after the cations contained in the water to be treated are removed, in EDI device 10, leakage of the cations can be prevented while improving the removal efficiency of the anions including the weak acid components represented by carbonic acid, silica, silicic acid compound, boric acid, and other boron compounds. This EDI device 10 can be stably operated over a wide range of water quality in the water to be treated.

By the way, in general, an EDI device can have a plurality of basic configurations each consisting of [concentration chamber | ion exchange membrane | deionization chamber | ion exchange membrane | concentration chamber] placed side-by-side between its anode and cathode via an ion exchange membranes. Two adjacent concentration chambers across an ion exchange membrane can be made into a single concentration chamber by removing the ion exchange membrane therebetween. In EDI device 10 shown in FIG. 1, N sets of these basic configurations can be placed between the concentration chamber 22 closest to anode chamber 21 and anion exchange membrane 34 in contact with cathode chamber 25, as one basic configuration is formed by anion exchange membrane 32, deionization chamber 23, cation exchange membrane 33, and concentration chamber 24. Nis an integer greater than or equal to 1. The fact that a plurality of basic configurations can be arranged side-by-side is indicated by notation of “×N” in the figure. When multiple basic configurations are placed side-by-side, all of the concentration chambers sandwiched by two adjacent deionization chambers 23 are concentration chamber 24, which is filled with the anion exchange resin and the cation exchange resin.

In the EDI device 10 in which a plurality of the basic configuration are juxtaposed, since deionization chamber 23 and concentration chamber 24 are arranged repeatedly, it is possible to stack a plurality of frames, each having an opening, in one direction so as to sandwich the ion exchange membrane (that is, the anion exchange membrane and the cation exchange membrane) thereby constituting each chamber such as deionization chamber 23 and concentration chamber 24 by the frame and the respective ion exchange membranes placed on a pair of the openings of the frame, as shown in Patent Literature 2. The frames are manufactured by, for example, injection molding of plastics. To increase the thickness of deionization chamber 23, the ion exchange membrane should not be placed between two or more consecutive frames in the stack of frames so that the two or more consecutive frames constitute deionization chamber 23 as a single unit. Even in EDI device 10 shown in FIG. 1, the thickness of deionization chamber 23 is about 20 mm, for example, while the thickness of concentration chambers 22 and 24 is about 10 mm, so that one deionization chamber can be made of two frames and each of concentration chambers 22 and 24 can be made of one frame.

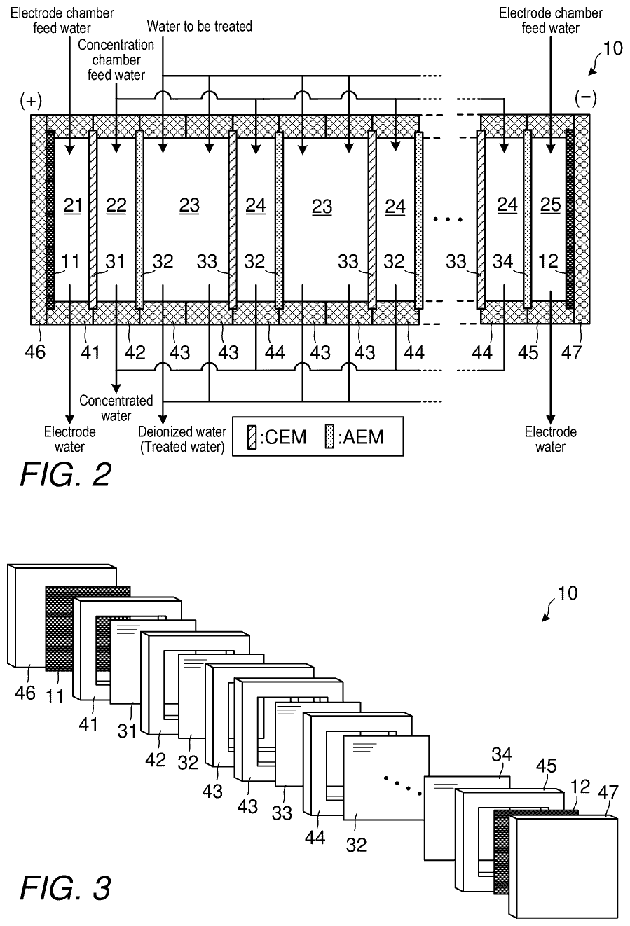

FIG. 2 shows an example of the mechanical structure when a plurality of basic configurations are juxtaposed in EDI device 10 shown in FIG. 1. FIG. 3 is an exploded perspective view of EDI device 10 shown in FIG. 2. In FIG. 2, the ion exchange resins respectively filled in anode chamber 21, concentration chambers 22 and 24, deionization chamber 23, and cathode chamber 25 are not shown. EDI device 10 shown in FIG. 2 has a configuration in which a plurality of frames 41 to 45 each having an opening are stacked. Anode 11 and cathode 12 are positioned at both ends in the stacking direction of frames 41 to 45 and face each other via the openings of frames 41 to 45. Anode chamber 21, concentration chamber 22, deionization chamber 23, concentration chamber 24, and cathode chamber 25 are composed of frames 41, 42, 43, 44 and 45, respectively. Anode 11 is fixed to frame 41 via holding plate 46, and cathode 12 is fixed to frame 45 via holding plate 47. With regard to deionization chamber 23, two frames 43 are stacked to form one deionization chamber. That is, two frames 43 are adjacent to each other so that their openings cooperatively form deionization chamber 23. When it is necessary to further increase the thickness of deionization chamber 23, deionization chamber 23 may be formed by three or more frames 43.

Frame 41, which constitutes anode chamber 21, and frame 42, which constitutes concentration chamber 22, are adjacent to each other, the openings of these frames 41 and 42 are separated by cation exchange membrane 31, so that anode chamber 21 and concentration chamber 22 are partitioned from each other. Similarly, anion exchange membrane 32 is placed between adjacent frame 42 and frame 43, cation exchange membrane 33 is placed between adjacent frame 43 and frame 44, and anion exchange membrane 34 is placed between adjacent frame 44 and frame 45.

By forming concentration chambers 22 and 24 and deionization chamber 23 by sequentially stacking the frames while interposing the ion exchange membrane in this way, EDI device 10 in which many basic configurations described above are arranged side-by-side can be easily manufactured. When stacking the frames, the frames are stacked with the openings facing upward. When filling each chamber (i.e., anode chamber 21, concentration chamber 22, desalination chamber 23, concentration chamber 24, and cathode chamber 25) with the ion exchange resin, the frame constituting the chamber is first stacked, the opening in the frame is then filled with the ion exchange resin, and then the next frame is placed over it with the ion exchange membrane interposed.

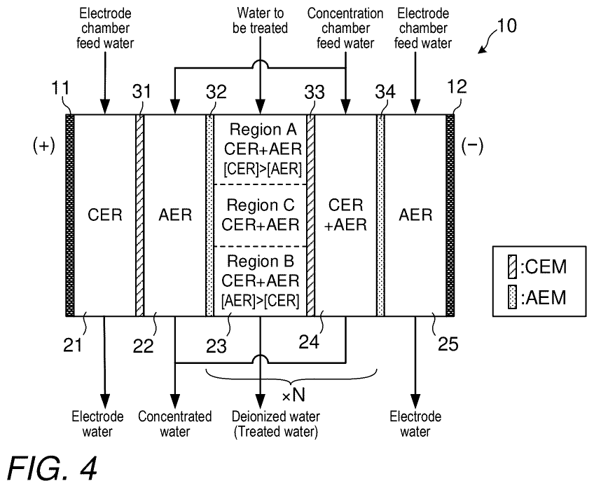

FIG. 4 shows EDI device according to another embodiment. In the EDI device based on the present invention, when deionization chamber 23 is divided into regions along the flow direction of the water to be treated, it can be divided into three or more regions. In the example shown in FIG. 4, region C is provided between region A and region B in deionization chamber 23 of EDI device 10 shown in FIG. 1. Region C is also filled with an anion exchange resin and a cation exchange resin in a mixed bed configuration, but in this region C, the mixing ratio of the anion exchange resin and the cation exchange resin may be arbitrary, and either anion exchange resin or cation exchange resin may be filled in a single bed configuration. In EDI device 10 shown in FIG. 4, concentration chamber 22 adjacent to anode chamber 21 is filled with an anion exchange resin in a single bed manner.

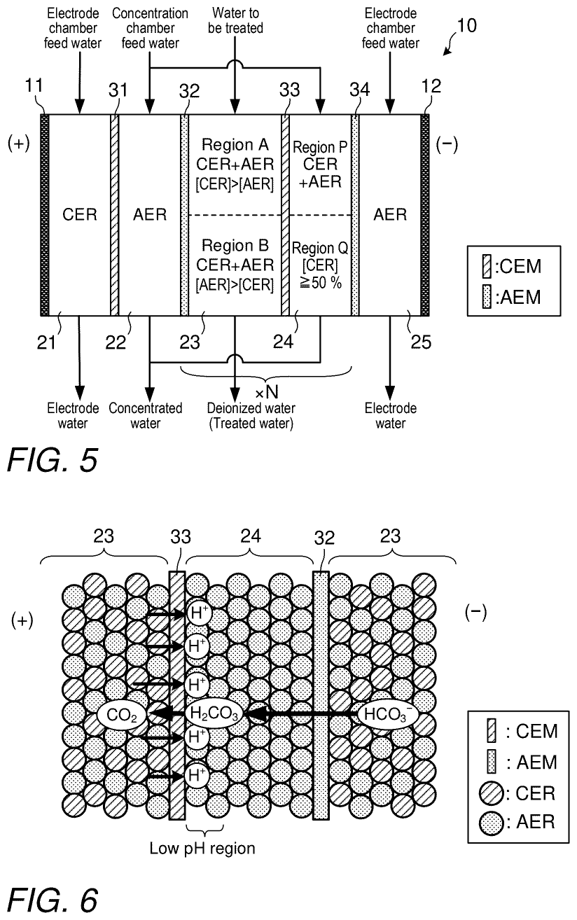

FIG. 5 shows EDI device 10 according to yet another embodiment. EDI device 10 shown in FIG. 5 is obtained by modifying EDI device 10 shown in FIG. 1 such that concentration chamber 24 is divided into two regions, that is, region P and region Q, along the flow direction of water in the concentration chamber disposed on the side to cathode 12 of deionization chamber 23. Region P is opposed to region A of deionization chamber 23 across cation exchange membrane 33, and, similarly, region Q is opposed to region B of deionization chamber 23 across cation exchange membrane 33. Here, “opposed to” means that a region present on one surface side of the ion exchange membrane (here, cation exchange membrane 33) and another region present on the other surface side of the ion exchange membrane are at least partially overlapped when viewed from a direction perpendicular to the membrane surface of the ion exchange membrane. Region P of concentration chamber 24 is filled with an anion exchange resin and a cation exchange resin in a mixed bed configuration. In region Q, a cation exchange resin may be filled in a single bed configuration, or an anion exchange resin and a cation exchange resin are filled in a mixed bed configuration. When region Q is filled in the mixed bed configuration, it is necessary that the ratio of the volume of cation exchange resin to the total volume of ion exchange resin filled in region Q is 50% or more. By increasing the ratio of the cation exchange resin in region Q, the leakage of weak acid components represented by carbonic acid, silica, silicate compounds, boric acid, and other boron compounds into the deionized water discharged from deionization chamber 23 can be suppressed. Also in EDI device 10 shown in FIG. 5, concentration chamber 22 adjacent to anode chamber 21 is filled with an anion exchange resin in a single bed manner.

FIG. 6 is a diagram illustrating the leakage of carbonic acid components from the deionization chamber. As shown in FIG. 6, it is assumed that deionization chambers 23 and concentration chambers 24 are alternately arranged between anode 11 and cathode 12, deionization chamber 23 is filled with the anion exchange resin (AER) and the cation exchange resin (CER) in a mixed bed manner, and concentration chamber 24 is filled with the anion exchange resin in a single bed manner. The carbonic acid components in the water to be treated (i.e., free carbonic acid (CO₂), bicarbonate ion (HCO₃⁻), and carbonate ion (CO₃²⁻)) are captured by the anion exchange resin as bicarbonate ion or carbonate ion in deionization chamber 23 on the right side of the figure, and are moved to concentration chamber 24 on the side to anode 11 through anion exchange membrane (AEM) 32. As a result, the ionic form of the anion exchange resin in concentration chamber 24 becomes HCO₃⁻ form. The electric field caused by the applied DC voltage causes the bicarbonate ions (and carbonate ions) in concentration chamber 24 to move to the vicinity of cation exchange membrane 33, but since they are anions, they cannot permeate cation exchange membrane 33. Thus, in concentration chamber 24, bicarbonate ions (and carbonate ions) are concentrated in the vicinity of cation exchange membrane 33, which is located on the side to anode 11 of concentration chamber 24.

Due to the applied DC voltage, hydrogen ions (H⁺) permeate into concentration chamber 24 through cation exchange membrane 33 from deionization chamber 23 on the side to anode 11 of concentration chamber 24. As a result, pH of the area near cation exchange membrane 33 decreases in concentration chamber 24. As mentioned above, this area is an area where hydrogen carbonate ions (and carbonate ions) are concentrated, water and carbon dioxide (CO₂) are generated from the hydrogen carbonate ions (and carbonate ions) due to the hydrogen ions, and a layer of water containing a high concentration of CO₂ is formed in the vicinity of cation exchange membrane 33 in concentration chamber 24. Carbon dioxide, a neutral molecule, can then permeate cation exchange membrane 33, so it moves from concentration chamber 24 to deionization chamber 23 through cation exchange membrane 33. Eventually, the carbonic acid component removed from the water to be treated in deionization chamber 23 is dissolved back into the water to be treated in deionization chamber 23 located on the side to anode 11 of that deionization chamber 23, and the treated water discharged from deionization chamber 23 will contain the carbonic acid component.

With respect to the leakage of carbonic acid components from the deionization chamber, the present inventors made the following findings. Namely,
(1) When the total carbonic acid concentration of the water to be treated supplied to deionization chamber exceeds 0.5 mg-CO₂/L, the leakage effect by the mechanism described above tends to begin to appear; and
(2) In general, the total carbonic acid concentration in water supplied to an EDI device is often less than 5 mg-CO₂/L because it is reduced by pretreatment in a preceding stage of the EDI device.

Total carbonic acid here collectively refers to free carbonic acid (CO₂), bicarbonate ions (HCO₃⁻), and carbonate ions (CO₃²⁻), and total carbonic acid concentration is the concentration of total carbonic acid expressed as a CO₂ equivalent concentration (mg-CO₂/L, i.e., mg/L as CO₂).

To prevent such leakage of carbonic acid components, it is conceivable to prevent the formation of an area of reduced pH in the vicinity of cation exchange membrane 33 in concentration chamber 24. To this end, it is effective to quickly transfer the hydrogen ions that have move to concentration chamber 24 through cation exchange membrane 33 to the side to cathode 12 in concentration chamber 24. In EDI device 10 shown in FIG. 5, the volume ratio of the cation exchange resin is set to 50% or more in region Q of concentration chamber 24 which corresponds to region B where the carbonic acid component is considered to be removed from the water to be treated in deionization chamber 23. With this configuration, it is possible to prevent a layer of water containing high concentrations of carbon dioxide from forming in the area near cation exchange membrane 33 in concentration chamber 24, thereby suppressing the transfer of carbon dioxide from concentration chamber 24 to deionization chamber 23 through cation exchange membrane 33.

As a method for suppressing the transfer of carbon dioxide from concentration chamber 24 to deionization chamber 23, in addition to a method in which the volume ratio of the cation exchange resin in region Q is set to 50% or more, there is a method in which, in concentration chamber 24, the volume ratio of the cation exchange resin in region P facing region A is made smaller than the volume ratio of the cation exchange resin in region A, which is the region on the most upstream side in deionization chamber 23, and, at the same time, the volume ratio of the anion exchange resin in region Q facing region B is made smaller than the volume ratio of anion exchange resin in region B, which is the most downstream region in deionization chamber 23. Since the amount of the cation resin is high in region A, it is difficult for anions to migrate out of the deionization chamber, but in this method, the anion exchange resin in region P, which is opposite region A there, can be increased to promote the movement of carbonic acid components from the deionization chamber to the concentration chamber.

### EXAMPLES

The present invention will be further described in detail below by way of Examples and Comparative Examples.

### Example 1

EDI device 10 with the configuration shown in FIG. 1 was assembled by stacking the frames. In concentration chambers 22 and 24, the anion exchange resin and the cation exchange resin are mixed and filled so that the volume ratio was 1:1. The thickness of deionization chamber 23 was 8.7 mm, and the dimension of the opening formed in the frame for deionization chamber 23 was 300 mm×150 mm. In deionization chamber 23, region A, which is upstream side of the flow of the water to be treated, was filled with a mixture of the anion exchange resin and the cation exchange resin so that the volume ratio (A:K) of the anion exchange resin (A) to the cation exchange resin (K) was 3:7. Region B, which is downstream side of the flow of the water to be treated, was filled with a mixture of the anion exchange resin and the cation exchange resin so that the volume ratio (A:K) was 8:2. The average particle size of the anion exchange resins used in deionization chamber 23 and concentration chambers 22 and 24 was 0.50 to 0.65 mm, and the average particle size of the cation exchange resins was 0.55 to 0.65 mm. The EDI device was operated by passing the water to be treated through deionization chamber 23 at a flow rate of 2.5 L/min per deionization chamber 23 while applying DC voltage between anode 11 and cathode 12. Specific resistance of the treated water obtained from deionization chamber 23 as deionized water was determined after 300 hours from the start of operation, and the determined specific resistance was used as the water quality value of the treated water. Water with a sodium ion concentration of 0.1 mg/L and a total carbonic acid concentration of 0.5 to 1.0 mg-CO₂/L was used as the water to be treated. The results are shown in Table 1.

### Example 2

EDI device 10 was assembled which was the same as in Example 1 except that the thickness of deionization chamber 23 was set to 17.7 mm, and EDI device 10 was operated in the same manner as in Example 1 except that the flow rate of the water to be treated per desalination chamber 23 was set to be 4 L/min, and the water quality value after 300 hours from the start of operation was determined. The results are shown in Table 1.

### Example 3

EDI device 10 was assembled which was the same as in Example 2 except that the anion exchange resin with an average particle diameter of 0.28 to 0.34 mm was used for use in deionization chamber 23, with a volume ratio (A:K) of 2:8 in region A on the upstream side and a volume ratio (A:K) of 7:3 in region B on the downstream side, and EDI device 10 was operated in the same manner in Example 2 to obtain water quality values after 300 hours from the start of operation. The results are shown in Table 1.

### Comparative Example 1

EDI device 10 was assembled which was the same as in Example 1 except that the volume ratio (A:K) in region A on the upstream side in deionization chamber 23 was set to 7.5:2.5 and the volume ratio (A:K) in region B on the downstream side was set to 6:4. EDI device 10 was operated in the same manner as Example 1, and the water quality value after 300 hours from the start of operation was obtained. The results are shown in Table 1.

### Comparative Example 2

EDI device 10 was assembled which was the same as in Example 1 except that the anion exchange resin and the cation exchange resin are mixed and filled in deionization chamber 23 so that the volume ratio (A:K) is 1:1 over the entirety of deionization chamber 23 without dividing deionization chamber 23 into regions, and EDI device 10 was operated in the same manner in is assembled in the same manner as in Example 1. The water quality value after 300 hours from the start of operation was obtained. The results are shown in Table 1.

TABLE 1

| | Example | Example | Example | Comparative | Comparative |
|---|---|---|---|---|---|
| | 1 | 2 | 3 | Example 1 | Example 2 |
| Thickness of deionization | 8.7 | 17.7 | 17.7 | 8.7 | 8.7 |
| chamber [mm] | | | | | |
| Average particle size of anion | 0.50 to | 0.50 to | 0.28 to | 0.50 to | 0.50 to |
| exchange resin in deionization | 0.65 | 0.65 | 0.34 | 0.65 | 0.65 |
| chamber [mm] | | | | | |
| A:K in region A (upstream | 3:7 | 3:7 | 2:8 | 7.5:2.5 | 1:1 |
| side) | | | | | |
| A:K in region A (downstream | 8:2 | 9:2 | 7:3 | 6:4 | 1:1 |
| side) | | | | | |
| Amount of water to be treated | 2.5 | 4 | 4 | 2.5 | 2.5 |
| [L/min] | | | | | |
| Water quality [MΩ · cm] | 12.8 | 14.9 | 17 | 5.2 | 11.4 |

In Examples 1 to 3, the water quality expressed by specific resistance was 12 MΩ-cm or more, and high-quality deionized water could be obtained. In particular, in Example 3 in which the anion exchange resin with an average particle size of 0.28 to 0.34 mm was used. a high value of 17 MΩ-cm could be obtained. In contrast, in Comparative Examples 1 to 2, the water quality was less than 12 MΩ-cm. When the time variation of the water quality was examined for Comparative Example 1, the water quality was above 15 MΩ-cm until about 200 hours of operation, after which the water quality deteriorated rapidly. This indicates that the sodium ion leakage from deionization chamber 23 is large in Comparative Examples 1 to 2, and that the leakage is particularly large when the operation time is longer. From the above results, it was found that, by increasing the ratio of the cation exchange resin on the most upstream end side the ratio of the anion exchange resin at the most downstream side in deionization chamber 23, the leakage of cations can be kept low while maintaining a high removal efficiency of anion components including weak acid components.

### REFERENCE SIGNS LIST

10 Electrodeionization device (EDI device);
11 Anode;
12 Cathode;
21 Anode chamber;
22, 24 Concentration chamber;
23 Deionization chamber;
25 Cathode chamber;
31, 33 Cation exchange membrane (CEM);
32, 34 Anion exchange membrane (AEM);
41 to 45 Frame; and
46, 47 Holding plate.

1. An electrodeionization device comprising: an anode; a cathode; a deionization chamber located between the anode and the cathode and partitioned by an anion exchange membrane located on a side to the anode and a cation exchange membrane located on a side to the cathode, the deionization chamber being filled with an anion exchanger and a cation exchanger; and a concentration chamber provided on a side to the cathode of the cation exchange membrane and filled with an anion exchanger and a cation exchanger,
wherein the deionization chamber is divided into a plurality of regions so that the plurality of regions are aligned in a flow direction of water to be treated in the deionization chamber, and among the plurality of regions, a region located at most upstream side of flow of the water to be treated is defined as a first region, and a region located at most downstream side is defined as a second region, and the first region is filled with a mixture of the anion exchanger and the cation exchanger such that a volume ratio of the cation exchanger to a total volume of the anion exchanger and the cation exchanger in the first region is more than 50% and 90% or less, and
wherein the second region is filled with a mixture of the anion exchanger and the cation exchanger such that a volume ratio of the anion exchanger to a total volume of the anion exchanger and the cation exchanger in the second region is more than 50% and 90% or less.

2. The electrodeionization device according to claim 1, wherein a thickness of an ion exchanger layer in each of the plurality of regions along a direction orthogonal to the flow direction of the water to be treated in the deionization chamber is 10 mm or more and 25 mm or less.

3. The electrodeionization device according to claim 1, wherein the anion exchanger filled in the deionization chamber is an anion exchange resin with an average particle size of 0.1 mm or more but 0.4 mm or less.

4. The electrodeionization device according to claim 1,
wherein a value obtained by dividing a volume in a free state of an ion exchanger in a regeneration state taken out from a chamber, which is at least one of the deionization chamber and the concentration chamber, after passing water into the chamber by a volume of the chamber is defined as a filling rate, and
wherein the filling rate of the ion exchanger in at least one of the deionization chamber and the concentration chamber is 100% or more but 110% or less.

5. The electrodeionization device according to claim 1, wherein a volume ratio of the cation exchanger in an ion exchanger filled in the concentration chamber at a position opposite the second region across the cation exchange membrane is 50% or more.

6. The electrodeionization device according to claim 1,
wherein a mixture of the anion exchanger and the cation exchanger having a smaller volume ratio of the cation exchanger than a volume ratio of the cation exchanger in the first region is filled in the concentration chamber at a position opposite the first region across the cation exchange membrane,
wherein a mixture of the anion exchanger and the cation exchanger having a smaller volume ratio of the anion exchanger than a volume ratio of the anion exchanger in the second region is filled in the concentration chamber at a position opposite the second region across the cation exchange membrane.

7. The electrodeionization device according to claim 1,
wherein a plurality of frames each having an opening are stacked via an ion exchange membrane to form at least the deionization chamber and the concentration chamber, and
wherein at least two of the plurality of frames are adjacent to each other such that the openings of the at least two frames jointly form the deionization chamber.

8. A method for producing pure water comprising: using the electrodeionization device according to claim 1; and supplying the water to be treated with a sodium ion concentration of 0.1 mg/L or more and 0.6 mg/L or less to the deionization chamber while applying a direct current voltage between the anode and the cathode to obtain pure water which is deionized water.

9. A method for producing pure water comprising: using the electrodeionization device according to claim 1; and supplying the water to be treated with a total carbonic acid concentration of 0.5 mg-CO₂/L or more and 5.0 mg-CO₂/L or less to the deionization chamber while applying a direct current voltage between the anode and the cathode to obtain pure water which is deionized water.
